(19) United States
(12) Patent Application Publication
(10) Pub. No.: US 2004/0204797 A1
(43) Pub. Date: Oct. 14, 2004

(54) Method and apparatus for regulating power in a vehicle

(76) Inventor: Mark F. Vickers, Kenmore, WA (US)

Correspondence Address: Mark F. Vickers, 17534 Ballinger Way NE, Seattle, WA, 98155, US

(21) Appl. No.: 10/346,364

(22) Filed: Jan. 16, 2003

(51) Int. Cl. G01C 21/26

(52) U.S. Cl. 701/1; 701/22; 701/201

(57) ABSTRACT

An apparatus for regulating an engine in a vehicle also powered by a motor receiving electricity from a storage cell. The apparatus may include a circuit that computes a distance from the vehicle to a predetermined destination and senses an amount of energy in the storage cell. The circuit may regulate the engine as a function of the distance and the energy in the storage cell.

### BACKGROUND OF THE INVENTION

This invention relates to a method and apparatus for regulating the power in a vehicle and more specifically to regulating power to an engine in a vehicle also powered by a motor.

Both an electric motor that runs the vehicle and an internal combustion engine typically powers hybrid vehicles. The motor is supplied electricity from a storage cell such as a battery. The engine is supplied fossil fuel or other consumable fuel—typically gasoline or diesel oil and is connected to a generator to re-charge the storage cell. Gasoline or diesel is supplied at a filling station. The storage cell is fully charged by connecting the cell to an electrical outlet for a period of time.

To maximize fuel efficiency of the vehicle, the vehicle is designed such that the motor powers the vehicle. Once the storage cell discharges below a power certain level, however, the engine is turned on to attempt to re-charge the storage cell. The engine continues to run until the cell is nearly charged and then turns off. This process repeats until the vehicle reaches its destination or runs out of fuel.

It may be more economical, convenient or environmentally friendly to charge the storage cell via an electrical outlet. However the charging process is totally random, and is dependent on the charge of the storage cell and not the location of the vehicle. Thus the vehicle could arrive at its destination with a fully charged cell, thereby depriving the vehicle operator the benefits of charging the cell using the electrical outlet. Also when the engine turns off, the vehicle runs quietly. Thus someone near the vehicle may not be alerted to the presence of the vehicle, creating a hazardous condition.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a simplified diagram of a vehicle having a device for regulating power to the vehicle in accordance with the invention;

FIG. 2 illustrates a Simplified Schematic diagram of the circuit for regulating vehicle power shown in FIG. 1; and

FIG. 3 illustrates a state diagram of an exemplary process for controlling the processor shown in FIG. 2.

### DETAILED DESCRIPTION OF EMBODIMENTS OF THE INVENTION

The present invention includes components of vehicles and receiver devices located therein, methods of operations practiced thereon, systems so formed, and other related subject matters.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in vehicle connection terminology, such as fuel cell, storage cell, memory and so forth, consistent with the manner commonly employed by those skilled in the two arts to convey the substance of their work to others skilled in the respective arts. These terms are well understood by those skilled in the respective arts. Section headings are merely employed to improve readability, and they are not to be construed to restrict or narrow the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

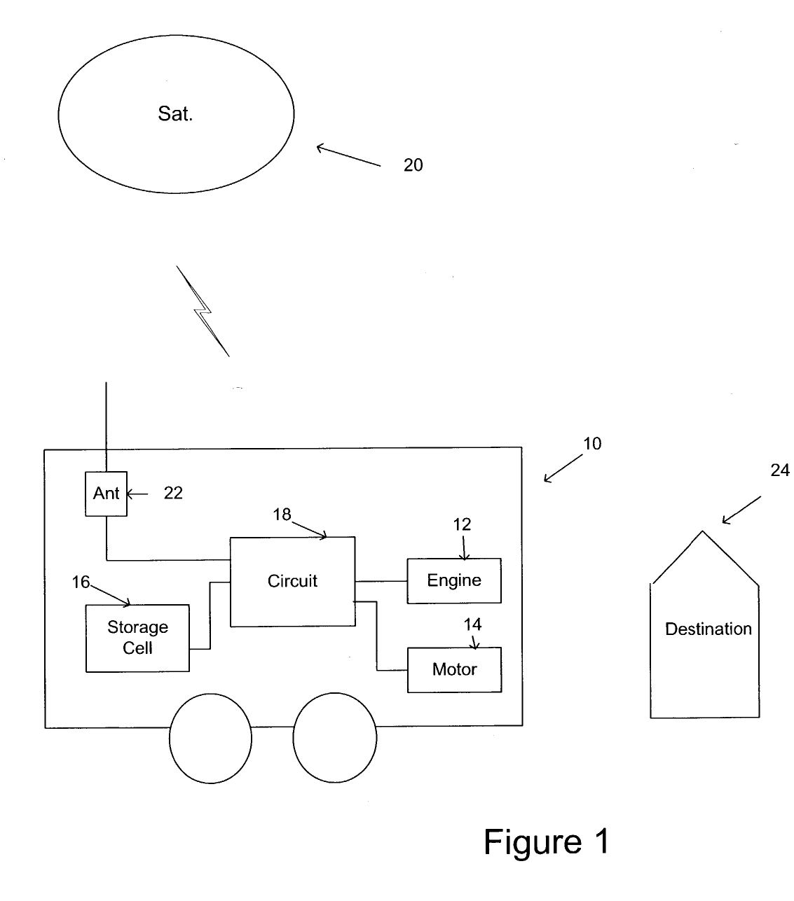

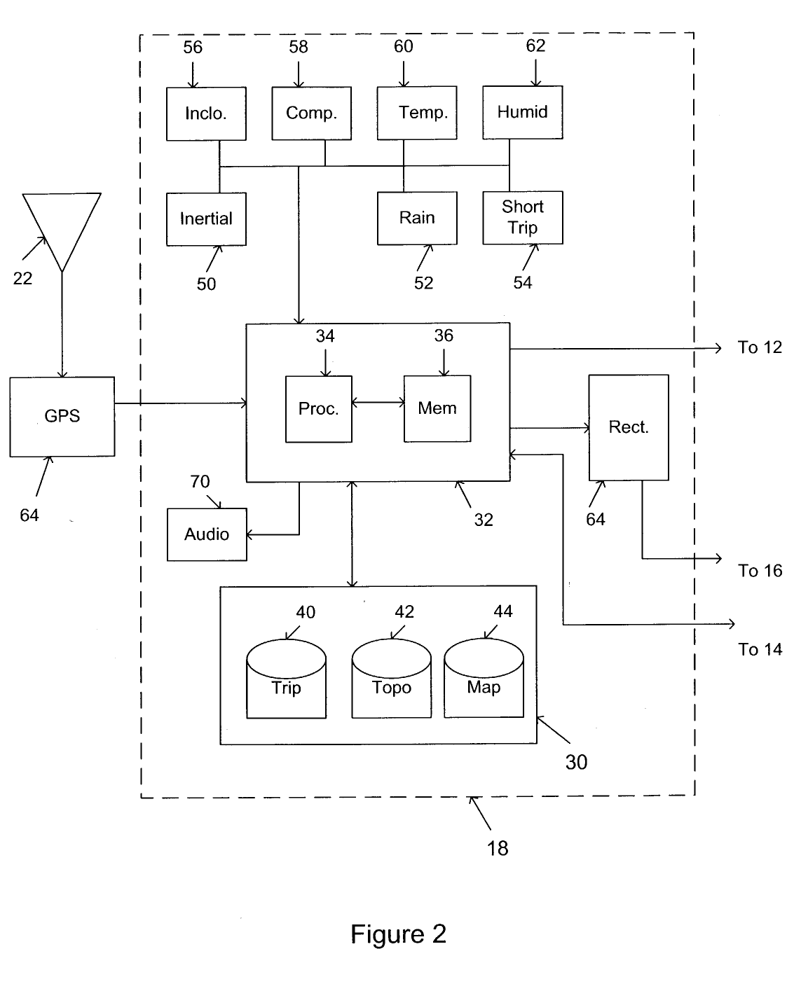

Referring to FIG. 1, there is shown a vehicle 10 powered by an engine 12 and a motor 14. The motor 14 obtains power from storage cell 16 using conventional means (not shown). The engine 12 may obtain fossil fuel or any consumable fuel using convention means, and powers storage cell 16, or engine 12 may directly power vehicle 10. Example consumable fuels may include diesel, hydrogen, aluminum or shale powder or gasoline. A circuit 18, shown in more detail in FIG. 2, may receive power from storage cell 16 and may monitor and/or regulate engine 12 and motor 14. Circuit 18 may receive a global positioning signal from a satellite 20 via antenna 22 and use the signal to indicating the relative position of vehicle 10. Although a GPS satellite is shown, controller may receive a signal from any conventional location indicator such as a LORAN transmitter (not shown), mobile or cellular transmitter. Circuit 18 may also receives a fuel level indication from storage cell 16.

Circuit 18 may be controlled by an operator in vehicle 10 and may contain a memory 30 (FIG. 2) indicating the location of a destination 24. In response to the signal from satellite 20 (or any position indicating transmission system), circuit 18 computes a distance to destination 24. In response to the computed destination and the fuel level indication, circuit 18 regulates engine 12 and motor 14.

Circuit 18 may be built into a vehicle 10, or built into a computer/monitor commonly provided with vehicles. Alternatively circuit 18 may a separate device such as a kit and may be retrofitted to be placed in existing vehicles or vehicle 10.

Referring to FIG. 2, there is shown circuit 18. Circuit 18 may have a controller 32 comprising a processor 34 coupled with a memory element 36. Memory element 36 may store instructions for the processor 34 and additional data. Controller 32 may be coupled with memory device 30, including but not limited to a hard drive, dvd or cd ROM drive. Memory device 30 may contain a plurality of conventional and commercially available databases such as a trip history database 40, land topography database 42 and/or a roadmap database 44. Instructions and databases may be loaded into memory device 30 by downloading them via an internet direct wired connection, wireless communication or mobile telephone systems. Controller 32 may be coupled with and receive signals from one or more of peripheral devices 50-62 including inertial indication 50, rain gage 52, short trip button 54, inclometer 56, compass 58, thermometer 60, and humidity device 62. Inertial indication 50 may also be coupled with the speedometer (not shown) of the vehicle 10 and provide an indication of the current speed of vehicle 10. Controller 32 may transmit audio indication signals to audio output device 70. Controller 32 may receive signals indicating the relative position of vehicle 10 with global positioning system receiver 64 that is coupled to antenna 22. Although in one embodiment circuit 18 may use GPS receiver 64 to obtain the location of vehicle, circuit may obtain the location of vehicle using other convention means including using compass 58, inclometer 56, or inertial navigation system 50. These other conventional means to obtain the vehicles location may be especially useful in tunnels, parking garages, heavily wooded areas or other places in which the GPS signal may not be available.

Controller 32 may be coupled to a conventional engine shutdown circuit 66 to enable and disable engine 12. Controller 32 may receive an indication of the fuel level of battery 16 from battery level indication circuit 64 coupled to battery 16. Alternately controller 32 may receive a signal from an inductive coupling device (not shown) coupled to battery 16 that provides an indication of the charging current being supplied thereto.

Trip history database 40 may contain the route of the vehicle 10 to and from destination 24, and may provide a log of the route of vehicle 10 previously traveled to and from destination 24. Topography database 42, may contain the topography of the route of the vehicle 10. Road map database 44 may contain the possible route the vehicle 10 can travel to reach destination 24 and the location, when used with a position indication system, of where the vehicle 10 is currently positioned on a road.

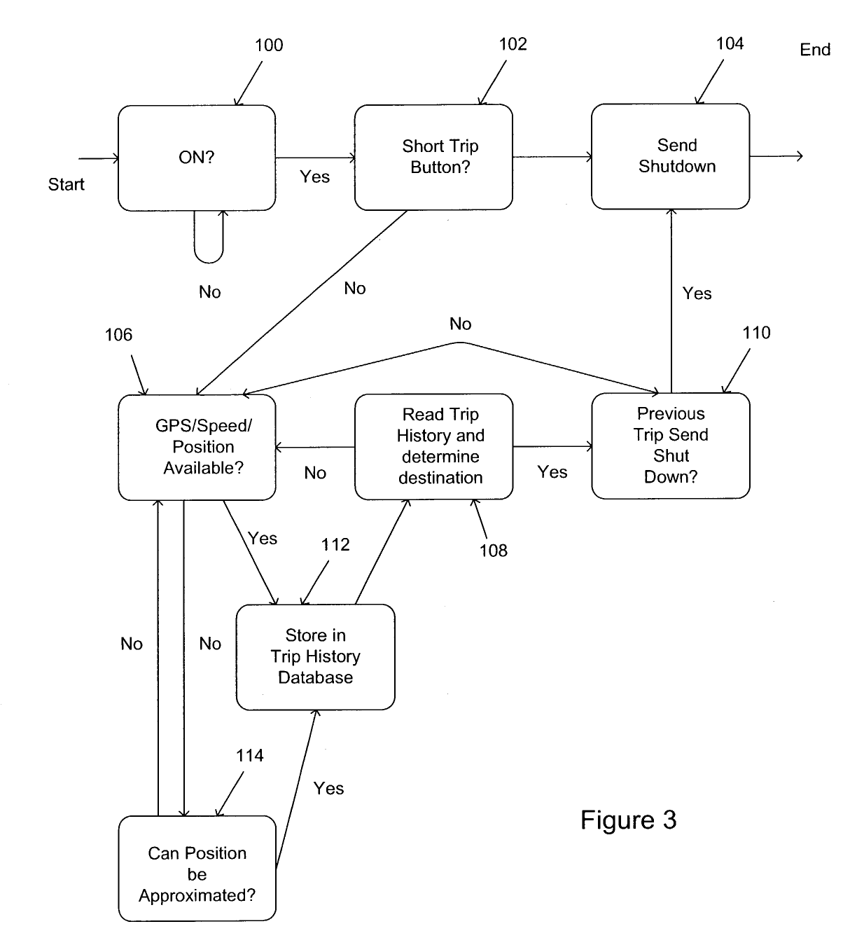

Referring to FIG. 3, there is shown processes, modules or instructions, such as those implemented by a state machine, executed by processor 34 in accordance with the claimed subject matter. Although a state machine instruction is shown, this process may be embodied in processor instructions such as by compiling source code into a machine object code. These instructions are preferably stored in memory 36 using conventional methods such as ROM or disk storage, or may be downloaded into memory 36 using wireless, wireline, cellular or direct network, or direct internet connections.

In module 100, processor 34 may continuously check to determine if the vehicle 10 is running by monitoring the storage cell 16, engine 12 and/or motor 14. If vehicle 10 is running, processor 34 may execute module 102.

In module 102, the processor 34 determines if short trip button 54 is engaged. If it is and the processor 34 determines there is still a charge in the storage cell 16 beyond a predetermined threshold (by sampling level indicator 64), processor 34 may transmit a signal to shutdown circuit 66 to indicate and request an engine shutdown. Processor 34 may ignore this engine shutdown in the event engine 12 must remain activated for vehicle to reach its destination or if the charge level of cell 16 falls below a predetermined amount. If the short tip button is not enabled, processor 34 may execute module 106.

In module 106, the controller determines by reading from GPS receiver 64, or any position indication device as previously described, using conventional methods, the speed, position and heading of vehicle 10. If the position, speed or heading is not directly available from the GPS receiver 34, that may be due to obstructions caused by trees, buildings, tunnels, overpasses or other GPS reception impediments, the processor 34 in module 114 determines if the position of the vehicle 10 can be approximated using any of the other peripheral devices 50, 52, or 56-62 and then may use these devices 50, 52, or 56-62 to determine the speed, position and heading of vehicle 10. Once the speed, position or heading of vehicle 10 is known, the processor 34 in module 112 may store this position into trip history database 40 in memory 30.

After storing the position of vehicle 10 in module 108, processor 34 may retrieve the route of vehicle 10 from trip history database 40 and determines if this previously stored route matches the current route of the vehicle 10. This current route may be input by the user. If no trip route has been entered, module 108, based, on previous trips can “determine” the likely destination and route using artificial intelligence referencing the trip history database 40.

Processor 34 may alternatively in module 110 determine the location of destination 24 (selected by the operator of vehicle 10 or previously stored in memory 36), and compute the distance of the vehicle 10 to the destination 24 or estimated time of the vehicle 10 to reach the destination. Such time or distance may be computed using either information stored in the trip 40, topographical 42 or map database 44 and the current speed or position of vehicle 10. Processor 34 may also read by monitoring storage cell 16 the amount of power remaining and determine if such power is enough for vehicle 10 to reach destination 24 without any additional power from engine 12 using convention power determination algorithms and factoring in the speed of the vehicle and/or computed distance to destination. If there is sufficient power in cell 16 for vehicle to reach destination 24, then a signal is sent to shutdown 66 to activate engine 12 shutdown. If such power is not sufficient, then processor 34 reexecutes module 106.

Alternately in module 110, the processor 34 may determines if the engine 12 was disabled at the current position in the previous trip, or one or more of the previous trips with similar environmental conditions, e.g. temperature, time of day, time of year, humidity, etc. Module 11- may be used to make estimating fuel need for vehicle 10 to reach destination 24 using more environmental conditions. If it was, then a shutdown signal may be sent to the engine 12 in module 104. If not, the processor 34 executes module 106. As another alternative, the processor 34 could determine if the time the engine 12 may be on to reach the destination 24 based on the average time of the previous trips. Processor 34 could then provide an indication to shut down engine 12 when such time is below a predetermined threshold. Further processor 34 may disable engine 34 by factoring the amount of energy stored in cell 16 and reduce or increase the time when engine 12 is to be disable using historical factors based on driving conditions, such as current wind, rain and humidity conditions of previous trips when such conditions are similar to the conditions of the current trip. For example if environmental condition of previous trips indicate that the time to reach the destination is likely to be increased, then an indication to shut down engine 12 may be delayed.

Thus, it can be seen from the above descriptions, an improved approach to conserve energy when traveling to a relatively known destination has been described. The method may increase fuel efficiency by shutting down an engine and using a remaining energy stored in a fuel cell to maximize use of recharging the device at the destination rather than using a likely less efficient source, namely using fossil or consumable fuel contained in the vehicle to recharge the fuel cell.

While the present invention has been described in terms of the foregoing embodiments and example applications, those skilled in the art will recognize that the invention is not limited to the embodiments and example application described. The present invention can be practiced with modification and alteration within the spirit and scope of the appended claims.

Thus, the description is to be regarded as illustrative instead of restrictive on the present invention:

What is claimed is:

1. An apparatus for regulating an engine in a vehicle at least partially powering a storage cell, said vehicle being powered by a motor receiving electricity from the storage cell, the apparatus comprising:
a circuit operative to compute a distance, time or relative location between the vehicle and a predetermined destination, and to sense an amount of energy in the storage cell, said circuit regulating the engine as a function of the distance, time or relative location and the energy in the storage cell.

2. The apparatus as recited in claim 1, wherein the storage cell is a battery.

3. The apparatus as recited in claim 1, wherein the circuit regulates the engine by turning the engine off.

4. The apparatus as recited in claim 1, wherein the circuit computes the distance by using a signal received from a satellite, using inertial navigation, using azimuth indication, using inclometer, or using a chronometer to determine the location of the vehicle.

5. The apparatus as recited in claim 4, wherein the circuit computes the distance by obtaining the location of the destination from a memory coupled to the circuit, and by computing the distance between the location of the vehicle and the obtained location of the destination.

6. The apparatus as recited in claim 4 wherein the circuit senses the distance by obtaining the location of the destination from locations stored in a memory indicating where the storage cell has previously been charged, and by computing the distance between the location of the vehicle and the obtained location of the destination.

7. The apparatus as recited in claim 1 wherein the circuit is operative to receive an indication to disable the engine, and wherein the circuit provides an indication to disable the engine in response to said indication and said distance being less than a predetermined amount.

8. The apparatus as recited in claim 3 further comprising an audio indicator that generates engine noise when the engine is turned off.

9. An method for regulating an engine in a vehicle also powered by a motor receiving electricity from a storage cell, the method comprising:
computing a distance from the vehicle to a predetermined destination;
sensing an amount of energy in the storage cell; and
regulating the engine as a function of the distance to the destination and the energy in the storage cell.

10. The method as recited in claim 9, wherein the storage cell is a battery.

11. The method as recited in claim 9 further comprising regulating the engine by turning the engine off.

12. The method as recited in claim 9, further comprising:
computing the distance by determining the vehicle location using a signal received from a satellite, using an inertial navigation, using an azimuth indication, using an inclometer, using a speedometer or using a chronometer.

13. The method as recited in claim 12 further comprising computing the distance by obtaining the location of the destination from a memory coupled to the circuit, and by computing the distance between the location of the vehicle and the obtained location of the destination.

14. The method as recited in claim 12 further comprising:
sensing the distance by obtaining the location of the destination from locations stored in a memory;
indicating where the storage cell has previously been charged; and
computing the distance between the location of the vehicle and the obtained location of the destination.

15. The method as recited in claim 9 further comprising providing an indication to disable the engine in response to an indication from a vehicle operator and said distance being less than a predetermined amount.

16. The method as recited in claim 11 further comprising providing an audio indication corresponding to engine noise when the engine is turned off.

17. The method as recited in claim 9 further comprising regulating the engine based on data stored in a memory indicating environmental conditions of previous trips.

18. A computer storage medium having instruction when executed comprise an method for regulating an engine in a vehicle also powered by a motor receiving electricity from a storage cell, the method comprising:
computing a distance from the vehicle to a predetermined destination;
sensing an amount of energy in the storage cell; and
regulating the engine as a function of the distance to the destination and the energy in the storage cell.

19. The computer storage medium recited in claim 18 further comprising regulating the engine based on data stored in a memory indicating environmental conditions of similar or previous trips.

20. A vehicle comprising:
an engine powered by consumable or fossil fuel;
a storage cell at least partially charged by the engine;
a motor receiving power from the storage cell;
a circuit operative to compute a distance from the vehicle to a predetermined destination and to sense an amount of energy in the storage cell; and
a circuit operative to regulate the engine as a function of the distance to the destination and the energy in the storage cell.

21. The vehicle as recited in claim 20, wherein the storage cell is a battery.

22. The vehicle as recited in claim 20, wherein the circuit regulates the engine by turning the engine off.

23. The vehicle as recited in claim 20, wherein the circuit is operative to compute the distance by using a signal received from a satellite, using inertial navigation, using azimuth indication, using inclometer, or using a chronometer and speedometer to determine the location of the vehicle.

24. The vehicle as recited in claim 23, wherein the circuit is operative to compute the distance by obtaining the location of the destination from a memory coupled to the circuit, and by computing the distance between the location of the vehicle and the obtained location of the destination.

25. The vehicle as recited in claim 23 wherein the circuit is operative to sense the distance by obtaining the location of the destination from locations stored in a memory indicating where the storage cell has previously been charged, and by computing the distance between the location of the vehicle and the obtained location of the destination.

26. The vehicle as recited in claim 20 wherein the circuit is operative to receive an indication to disable the engine, and wherein the circuit provides an indication to disable the engine in response to said indication and said distance being less than a predetermined amount.

27. The vehicle as recited in claim 22 further comprising an audio indicator that generates engine noise when the engine is turned off.

28. The vehicle as recited in claim 9 further comprising a device operative to regulate the engine based on data stored in a memory indicating environmental conditions of the vehicles similar or previous trips.
